(19) United States
(12) Patent Application Publication
(10) Pub. No.: US 2013/0161150 A1
(43) Pub. Date: Jun. 27, 2013

(54) PULLEY ASSEMBLY WITH A DECOUPLING MECHANISM

(71) Applicant: Paul T. McCrary, Belleville, MI (US)

(72) Inventor: Paul T. McCrary, Belleville, MI (US)

(21) Appl. No.: 13/713,247

(22) Filed: Dec. 13, 2012

Related U.S. Application Data
(60) Provisional application No. 61/576,487, filed on Dec. 16, 2011.

(51) Int. Cl. F16D 43/04

(52) U.S. Cl. CPC F16D 43/04
USPC 192/41 R; 192/103 R; 192/93 R; 192/94; 192/89.2; 192/66.2; 192/70.23

(57) ABSTRACT

Various pulley assemblies are described that include a pulley body, a hub defining an axis of rotation disposed within a bore of the pulley body, and an actuator and a clutch mechanism disposed about the hub. The actuator axially expands when the pulley body rotates in a predominant direction, and the clutch mechanism is activated thereby into an engaged position. In this engaged position, the clutch mechanism links the pulley body to the hub for simultaneous rotation in the predominant direction. Then, when the pulley body rotates in a non-dominant direction or experiences a deceleration, the pulley assembly enters an overrun position where the clutch mechanism disengages and allows the hub to rotate at speeds greater than the pulley body. Additionally, a reverse configuration is described where the actuator axially expands when the hub rotates and the clutch mechanism, when engaged, links the hub to the pulley body.

### RELATED APPLICATIONS

This application claims the benefit of U.S. provisional Application No. 61/576,487 filed Dec. 16, 2011.

### TECHNICAL FIELD

The present application relates generally to pulleys and more particularly to a pulley assembly that includes a decoupling mechanism.

### BACKGROUND

It is known to drive various automobile accessory assemblies, including for example a water pump, an alternator/generator, a fan for cooling coolant, a power steering pump, and a compressor, using the vehicle engine. In particular, a driving pulley actuated by an engine shaft of the motor vehicle drives an endless drive belt that in turn drives the accessory assemblies through driven pulleys.

Periodic torque pulses initiated by, for example, combustion engine firing can create significant speed transitions which can interrupt smooth operation of the driven components. In addition, inertial and driven speed transitions associated with startup, shutdown, jake braking, gear shifting, etc. can also interrupt operation of the driven components. These transitions can result in undesirable effects such as belt jump, belt wear, bearing wear, noise, etc.

The engine, driving belt system, and driven accessory are comprised of primary and additional driving/driven speeds and frequencies. These are characteristic of the system and usually will meet desired operating targets while being relatively stiffly connected by the belt drive system. However at some operating points and/or conditions these speeds and frequencies contribute to unwanted noise, compromise system or component integrity, or contribute to reduced service life of the belt system or individual component. Current solutions provide for overrunning of an accessory exist and others provide for torsional isolation, but improvements are needed that outperform, last longer, and are more cost effective to manufacture.

### SUMMARY

Improved driven or driver pulley assemblies are disclosed that utilize torque-sensitive coupling and de-coupling to permit one-way relative motion between an input shaft of a driven accessory and an outer driven sheave of the pulley assembly or between a crank shaft and an outer drive sheave of the pulley assembly.

For a driven pulley assembly, when the sheave of the pulley assembly is being driven in the predominant direction of rotation, the clutching mechanism of the pulley assembly engages and drives the accessory input shaft for the desired smooth rotation. When relative torque reversals occur as a result of, for example, driven speed transitions, the internal clutching mechanism of the proposed pulley assembly disengages the driven accessory shaft from the outer driven sheave, thereby permitting the driven shaft to continue to rotate with momentum in the predominant direction of rotation even at speeds greater than the driven sheave of the pulley.

For a driver pulley assembly, when the hub of the pulley, which is coupled to a crank shaft, is rotated in the predominant direction of rotation, the clutching mechanism of the pulley assembly engages and drives the sheave of the pulley assembly for the desired smooth rotation. When relative torque reversals occur as a result of, for example, crank shaft speed transitions, the internal clutching mechanism of the proposed pulley assembly disengages the sheave of the pulley assembly from the hub (crank shaft), thereby permitting the sheave of the pulley to continue to rotate with momentum in the predominant direction of rotation even at speeds greater than the hub or crank shaft.

In one aspect, belt drive assemblies for driving belt driven accessories in an engine of an automotive vehicle, and more particularly, to a decoupling mechanism for allowing the belt driven accessories to operate temporarily at a speed other than the belt drive assembly are also provided. Here the belt drive assembly includes the improved driven pulley described above, at least one driver pulley, and an endless belt entrained about both pulleys. In another embodiment, the belt drive assembly may include the improved driver pulley at the crank shaft, at least one driven pulley and an endless belt entrained about both pulleys. In yet another embodiment, the belt drive assembly may include the improved driver pulley at the crank shaft, the improved driven pulley, and an endless belt entrained about both pulleys.

The pulley assemblies disclosed herein provide both overrunning and decoupling capability that exceeds current performance and maintains the level of practicality demanded by the automotive industry. In one embodiment, the pulley assembly includes a pulley body having a bore, a hub defining an axis of rotation disposed within the bore of the pulley body, and an actuator and a clutch mechanism disposed about the hub. The actuator is capable of axial expansion when the pulley body rotates in a predominant direction and the clutch mechanism is activated, moved into an engaged position, by the axial expansion of the actuator. This engaged position links the hub to the pulley body for simultaneous rotation in the predominant direction. Then, when the pulley body rotates in a direction opposite the predominant direction or experiences a deceleration, the clutch mechanism disengages from the actuator and allows the hub to rotate independently of the pulley body, still, in the predominant direction under its own momentum. In other words, the pulley assembly enters an overrun position where the clutch mechanism disengages from the actuator and allows the hub to rotate at speeds greater than the pulley body.

The actuator within the pulley assembly may be a ramp-ramp, roller-ramp, ball-ramp, cam follower, or ball screw unit that expands axially when the pulley body rotates in the predominant direction. If the actuator is the roller-ramp unit, the roller-ramp unit includes one or more roller elements disposed between an upper ramp component and a lower ramp component. If the actuator is a ball screw unit, the ball screw unit includes a nut coupled to the pulley body for rotation therewith and being translatable relative thereto, a threaded shaft about which the nut is disposed, and a plurality of rolling elements recirculating within a raceway defined between the nut and the threaded shaft.

The clutch mechanism within the pulley assembly may be a clutch pack or a cone clutch. If it is the clutch pack, it includes at least one clutch plate and at least one friction disc and either the clutch plate or the friction disc are coupled to the hub for rotation therewith while being translatable therealong and the other is coupled to the actuator for rotation therewith while being translatable along the hub.

The pulley assembly may also include a biasing member that biases the components of the actuator axially into maintained contact during operation of the pulley assembly. The biasing member may be disposed between the actuator and a cap or between the actuator and the clutch mechanism. In one embodiment, the biasing member includes one or more Belleville washers. In another embodiment, the biasing member is a coil spring.

In an embodiment where the pulley assembly is a driver pulley mounted to a crank shaft, the actuator is coupled to the hub for axial expansion in response to the rotation of the hub and the clutch mechanism is activated by the axially-expanding actuator into an engaged position that couples the hub to the pulley body for simultaneous rotation together. Then, when the clutch mechanism is decoupled in response to the contraction of the actuator, the pulley assembly “overruns” and allows the pulley body to continue to rotate under its own momentum at speeds greater than those of the hub (and crank shaft).

Advantages and features of the invention will be apparent from the following description of particular embodiments and from the claims.

### BRIEF DESCRIPTION OF THE DRAWINGS

FIG. 1 is a diagrammatic view of an embodiment of an accessory drive system.

FIG. 2 is an exploded, perspective view of one embodiment of a pulley assembly for use in an accessory drive system such as that illustrated in FIG. 1.

FIG. 3 is a side, section view of the pulley assembly of FIG. 2.

FIG. 4 is an exploded, perspective view of a second embodiment of a pulley assembly for use in an accessory drive system such as that illustrated in FIG. 1.

FIG. 5 is a side, section view of the pulley assembly of FIG. 4.

FIG. 6 is an exploded, perspective view of a third embodiment of a pulley assembly for use in an accessory drive system such as that illustrated in FIG. 1.

FIG. 7 is a side, section view of the pulley assembly of FIG. 6.

FIG. 8 is a perspective view of a portion of the actuator included in the pulley assembly of FIG. 6.

FIG. 9 is an exploded, perspective view of one embodiment of a pulley assembly for use in an accessory drive system such as that illustrated in FIG. 1.

FIG. 10 is a side, section view of the pulley assembly of FIG. 9.

FIG. 11 is a sectional view of one embodiment of a ramp plate as illustrated in FIG. 9.

FIG. 12 is an exploded, perspective view of an alternate embodiment of the pulley assembly of FIG. 2 for use in an accessory drive system such as that illustrated in FIG. 1.

FIGS. 13A and 13B are side, perspective views of the clutch actuator of the pulley assembly in FIG. 12 illustrating an assembled position (FIG. 13A) and a maximum travel position (FIG. 13B).

FIG. 14 is a graph of a damper curve for the pulley assembly of FIG. 12.

FIG. 15 is an exploded, perspective view of an alternate embodiment of the pulley assembly of FIG. 2 for use in an accessory drive system such as that illustrated in FIG. 1.

FIG. 16 is an assembled, cross-sectional view of the pulley assembly of FIG. 15.

FIG. 17A is a sub-assembly of the actuator and drive plate within the pulley assembly of FIG. 15.

FIG. 17B is an exploded perspective view of the sub-assembly of FIG. 17A.

### DETAILED DESCRIPTION

The following detailed description will illustrate the general principles of the invention, examples of which are additionally illustrated in the accompanying drawings. In the drawings, like reference numbers indicate identical or functionally similar elements.

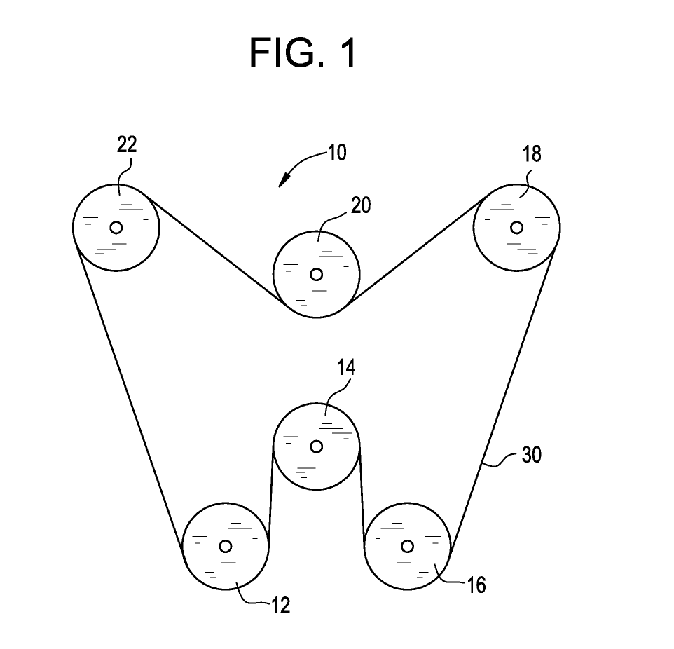

Referring to FIG. 1, an accessory drive system 10 of, for example, an internal combustion engine of an automobile includes an endless belt 30 that is used to drive a number of accessories. The various accessories are represented in FIG. 1 diagrammatically by their pulley assemblies. The belt 30 is entrained around a crank pulley assembly 12, a fan/water pump pulley assembly 14, a power steering pulley assembly 18, an idler pulley assembly 20 and a tensioner pulley assembly 22. In some embodiments, the tensioner pulley assembly 22 includes damping, such as asymmetric damping with a frictional damper to resist lifting of the tensioner arm away from the belt 30.

The various accessories are driven through use of pulley assemblies 14, 16, 18, 20 and 22 that are themselves rotated by the belt 30. For purposes of description, pulley assembly 16 of an alternator will be focused on below. It should be noted, however, that the other pulley assemblies of one or more of the other accessories may also operate in a fashion similar to that of pulley assembly 16.

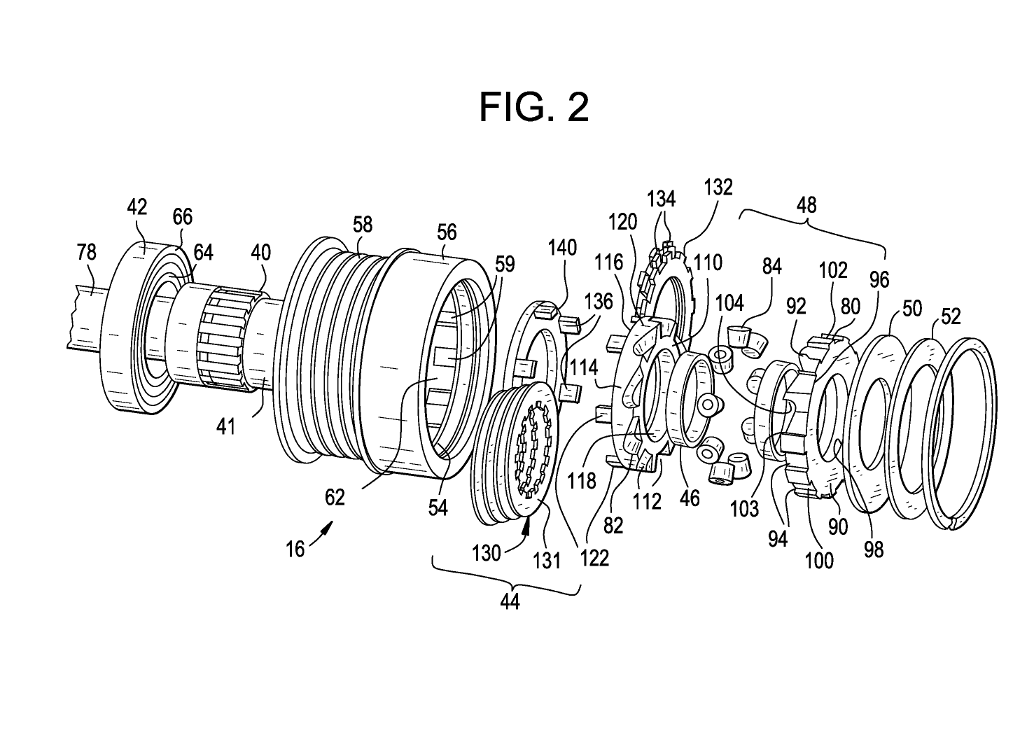

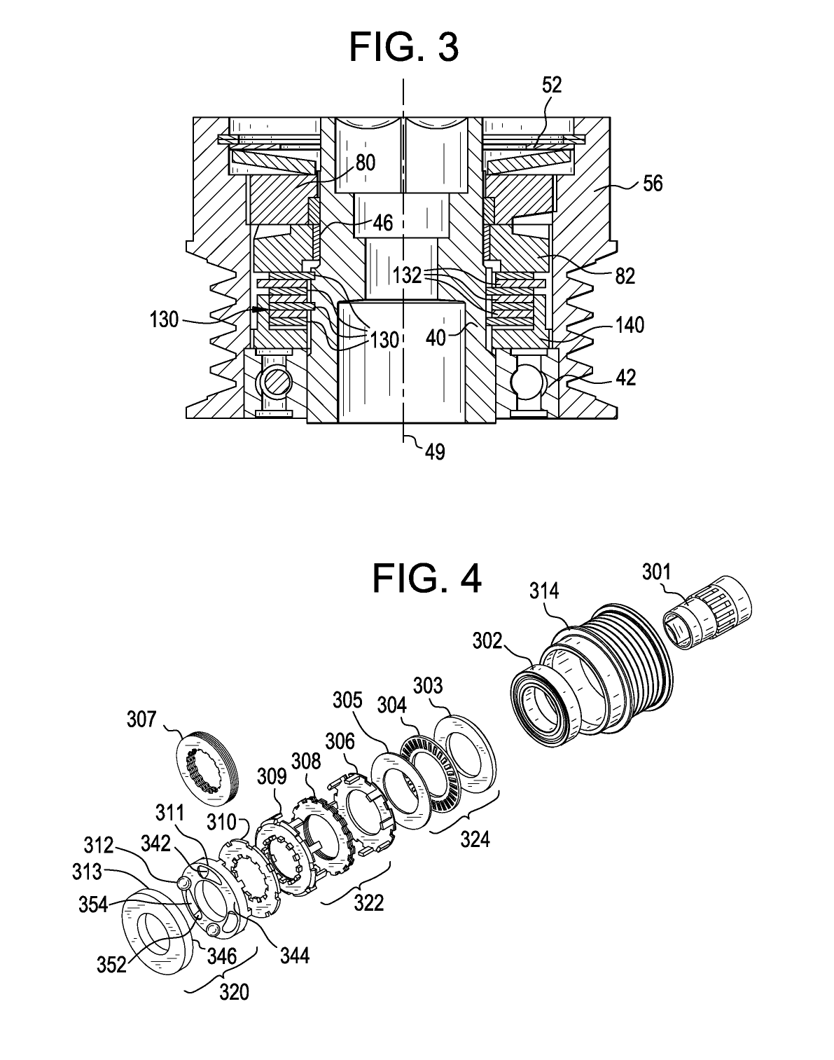

Referring now to FIGS. 2 and 3, pulley assembly 16 transfers input torque from the belt 30 to the input shaft 78 of an accessory, for example an alternator or fan, when rotated in a predominant rotational direction and also isolates the input shaft 78 from relative torque reversals between the pulley assembly 16 and the input shaft 78. When such relative torque reversals between the pulley assembly 16 and the input shaft 78 occur, an internal decoupler system of the pulley assembly 16 acts to disengage the input shaft 78 from the torque reversal, also referred to as an overrunning condition, thereby permitting the accessory input shaft 78 to continue rotating with momentum in the predominate operational direction.

The pulley assembly 16 includes a hub 40 that is engageable with the input shaft 78 of the accessory, a roller bearing 42, a one-way clutch mechanism 44, a friction ring 46, a clutch actuator 48, a biasing member 50, and a closure member 52 (or cap) that are all housed within the bore 54 of a pulley body 56. The hub 40 may be mated to the input shaft 78 by a Woodruff key, as is well known, to prevent the hub 40 from freely rotating about the input shaft. Of course other connections between the hub 40 and the input shaft 78 are also possible including, for example, a spline. The roller bearing 42 may be located between the hub 40 and the pulley body 56 to permit stable rotation of the pulley body 56 relative to the hub 40 when disengaged. The inner race 64 of the roller bearing 42 may be adjacent and coupled to the hub 40. The outer race 66 of the roller bearing 42 may be adjacent and coupled to the pulley body 56. The use of a roller bearing may improve the overall structural rigidity of the assembly and extend the life of the assembly by reducing wear as elements of the clutching mechanism rotate relative to one another.

As illustrated in FIGS. 2 and 3, the pulley body 56 is located about the hub 40 and includes a central bore or opening 54 that is sized such that the pulley body can rotate about the hub. The pulley body 56 also includes an outer, peripheral belt-engaging surface 58 that engages belt 30 (FIG. 1), and a coupling feature 59 within the inner surface 62 that defines the bore 54. In the illustrated embodiment, the belt engaging surface 58 is profiled including V-shaped ribs and grooves to mate with corresponding ribs and grooves on the belt 30. Other configurations are possible, such as cogs, flat or rounded ribs and grooves. The coupling feature 59 on the inner surface 62 (most easily seen in FIG. 2) may be grooves, pathways, slots, keyways, or the like recessed into the inner surface 62. Alternately, the coupling feature 59 may be a protrusion, tab, key, splines, or the like on the inner surface 62 that protrude or extend inward (toward the axis of rotation). The coupling feature 59 is configured to engage a mating coupling feature 102 on a member of the clutch actuator 48. The engagement of the mating coupling feature 102 with the coupling feature 59 provides for rotation of the pulley body 56 with a member of the clutch actuator (i.e., transfer torque from the pulley body 56 to other components).

The clutch actuator 48 includes a ramp construction or a roller-ramp construction that expands axially (i.e., has at least one component that is translatable along the axis of rotation 49 to a location that is further from another component thereof) as a result of rotational movement of at least a portion of the clutch actuator. The axial expansion typically is a result of one component moving up or along an inclined feature or moving in response to the movement of a rolling element up or along an inclined feature. The use of the clutch actuator 48 to actuate the one-way clutch mechanism 44 provides the pulley assembly 16 with isolation or damping capability. The clutch actuator in the embodiment of FIGS. 2 and 3 includes an upper ramp component 80 and a lower ramp component 82 with a roller element 84 enclosed therebetween. Upper and lower are used herein as relative to positions of the components of the pulley assembly 16 as illustrated in FIG. 3 with respect to the orientation of the page. The terms upper and lower are likewise applicable to the other drawings herein. The upper ramp component 80 is generally located adjacent to the spring 50, which is illustrated as a Belleville washer, and the lower ramp component 82 is generally located adjacent to the other components of the one-way clutch mechanism 44.

The upper ramp component 80 has a generally smooth upper surface 90, a lower surface 92 comprising one or more first inclined features 94 recessed into the body 96 of the upper ramp component 80, an inner surface 98 defining a bore for receiving the hub 40, and an outer surface 100 having one or more mating coupling features 102. In the assembled state (FIG. 3), the upper ramp component 80 is coupled to the pulley body 56 by engaging the mating coupling features 102 with the coupling features 59 in the pulley body 56. Accordingly, the upper ramp component 80 is fixed to the pulley body 56 for rotation therewith, but is free to translation relative thereto while maintaining engagement of the coupling features 59, 102. The pulley assembly 16 is constructed such that when the upper ramp component 80 translates relative to the pulley body 56, the coupling features 59, 102 provide frictional contact therebetween, which provides beneficial coulomb damping.

The first inclined features 94, best seen in FIG. 2, define a channel within which a roller element 84 is seated. The channel has a first end 103 that is shallow relative to a second end 104 (i.e., the second end is recessed more deeply into the body 96 of the upper ramp component 80). For smooth angular displacement of the upper ramp component 80 (and rotation of the roller element 84) the channel is preferably smoothly, gradually tapering from the first end 103 to the second end 104.

The lower ramp component 82 has an upper surface 110 comprising one or more second inclined features 112 recessed into the body 114 of the lower ramp component 82, a generally smooth lower surface 116, an inner surface 118 defining a bore for receiving a friction ring 46, which together receive the hub 40, and a generally smooth outer surface 120. The lower surface 116 includes one or more tabs 122 extending axially downward away from the lower surface. The tabs 122 are positioned generally proximate to the outer surface 120 of the lower ramp component 82 and create a corral to contain one or more components of the one-way clutch mechanism 44, in particular a clutch pack 130 (FIG. 3). The second inclined features 112 are similarly constructed to those in the upper ramp component 82, except that the orientation of the first end and second end of the second inclined features 112 is reversed relative to the orientation of the first and second ends 103, 104 of the first inclined features 94.

The roller elements 84 received in opposing first and second inclined features 94, 112 may be cylinders, balls, generally conical cylinders, or the like.

The friction ring 46 is fixed to the lower ramp component 82 such that they rotate together. As assembled in FIG. 3, the friction ring 46 rubs against the shaft portion 41 of the hub 40 during rotation. This frictional contact retards the motion of the lower ramp component relative to the pulley body 56 thereby allowing the upper ramp component 80 and the lower ramp component 82 to not rotate together. This creates circumferential divergence where both can still rotate, but in opposite directions and not necessarily at the same speed. This relative rotation will move the roller elements 84 within, up, or along the first and second inclined features 94, 112 to axially translate the first and second ramp components relative to one another.

The axial expansion of the actuator 48 during rotation of the pulley body 56 in the predominate rotational direction actuates the one-way clutch mechanism 44 which couples the pulley body 56 to the hub 40 to transmit power from the belt 30 (FIG. 1) to the input shaft 78 (FIG. 2) of an accessory. The one-way clutch mechanism 44 includes a plurality of alternating friction discs 130 and friction core plates 132. Each friction disc 130 and friction core plate 132 has a bore therethrough to receive the shaft 41 of the hub 40.

The pulley assembly 16 also includes a biasing element 50 (FIGS. 2 and 3) that becomes compressed as the ramp-ramp, roller-ramp, cam follower, or ball screw components expand, in particular, as the upper and lower ramp components 80, 82 axially expand apart. The compression of the biasing element 50 translates to a torsion rate across the device. Coulomb damping, described above, is created by the friction between the upper ramp component 80 sliding against the pulley body 56 during stroke of the spring and as the friction ring 46 slides against the hub 41. Thus, the input and output are decoupled, or isolated, from torsional excitations, generally of the input, by this roller-ramp/spring damper configuration. Spring rate can be varied, through selection of spring, to match system requirements. The ramp or include angle or profile can be modified to enhance and/or tailor isolation characteristics.

Interposed between the actuator 48 and the roller bearing 42 is a clutch 44 that includes a clutch pack 130. As shown in FIG. 2, the clutch pack includes alternating friction discs 131 and friction core plates 132. The friction discs 131 have an inner diameter that defines a surface that includes a key or keyway for mating engagement with the hub 40 for rotation therewith. In one embodiment the friction discs 131 and the hub 40 have a splined connection. The friction core plates 132 include a key, keyway, tabs, splines, cogs, or the like 134 in the surface defining its outer diameter. The cogs 134 are received between tabs 122 on the lower ramp component 82 and similarly configured second tabs 136 on holder 140 to form a cage or corral around the clutch pack 130.

The pulley assembly 16, in particular the hub 40 thereof, defines an axis of rotation 49 as labeled in FIG. 3. When the one-way clutch mechanism 44 is engaged, the pulley body 56 rotates the input shaft 78 of the accessory. The engaged position is achieved by angular displacement provided through the relative rotation of the pulley body 56 and the component(s) of the actuator 48 that are rotationally fixed to the pulley body. In FIGS. 2 and 3, the upper ramp component 80 is fixed to rotate with the pulley body. Rotation of the upper ramp component 80 via rotation of the pulley body 56 moves the roller element 84 within the inclined features 94, 112, which expands the actuator by translating the upper and lower ramp components axially. This axial translation compresses biasing member 50, which in turn urges all the components of the actuator 48 to translate axially toward the clutch 44 to compress the clutch pack 130 for increased frictional engagement between the friction disc 130 and the friction core plate 132. Once the clutch pack 130 is compressed into a frictional engagement that allows all the components of the clutch pack to rotate together as a unit, the hub 40, which is coupled to the friction discs 130 for rotation therewith, will rotate with the pulley body 56. This is the engaged position of the clutch.

During an overrunning condition, the input shaft 78 disengages from the pulley assembly, in particular from the pulley body 56, and continues to rotate with momentum in the first rotational direction (the predominant direction) when the pulley body 56 experiences a relative torque reversal or sudden slowdown. In this condition, the pulley body 56 may continue to rotate in the first rotational direction but with less angular velocity than the velocity at which it had been driving the input shaft 78. The sudden decrease of angular velocity at the pulley body 56 has the effect of a relative reversal of torque, which rotates at least one component of the actuator 48 through rotation of the pulley body 56 to compress the actuator (i.e., reduce the axially expansion of the actuator), which relieves the clutch 44 of the compressive forces that moved it into an engaged position. As the contact pressure and friction force between the actuator 48 and the clutch 44 decrease, they will eventually disengage the clutch 44, which uncouples the pulley body 55 from the hub 40 so that they can rotate relative to one another with minimal friction such that the input shaft 78 rotates independently of the pulley body 56.

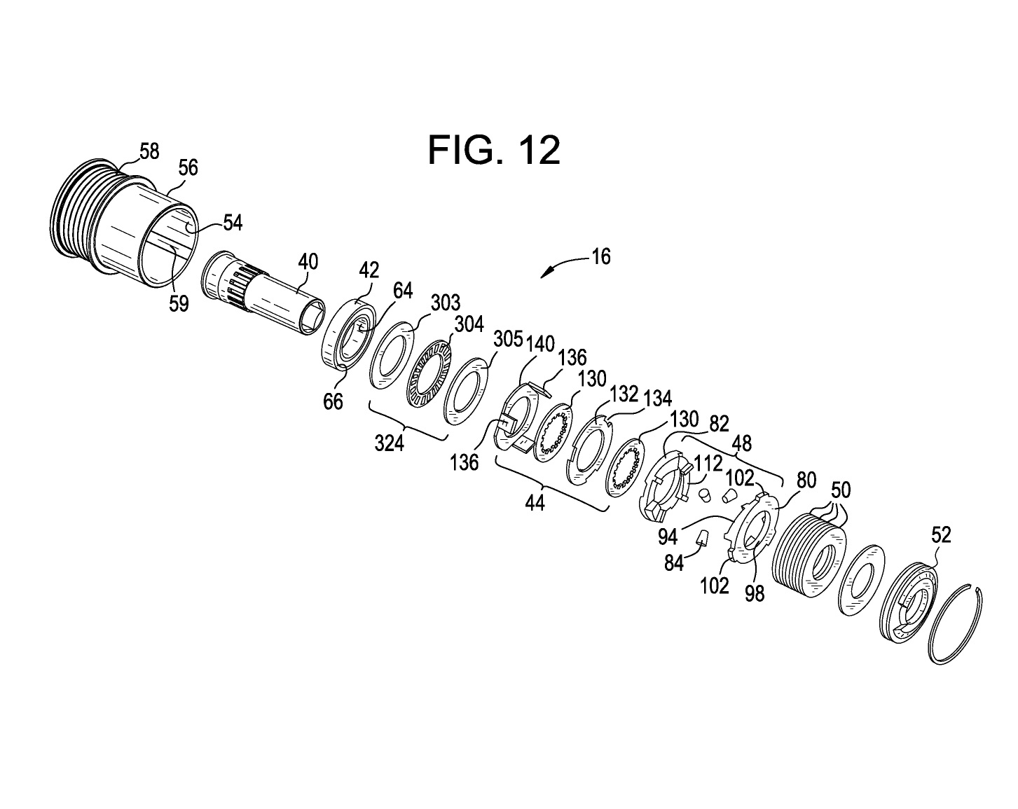

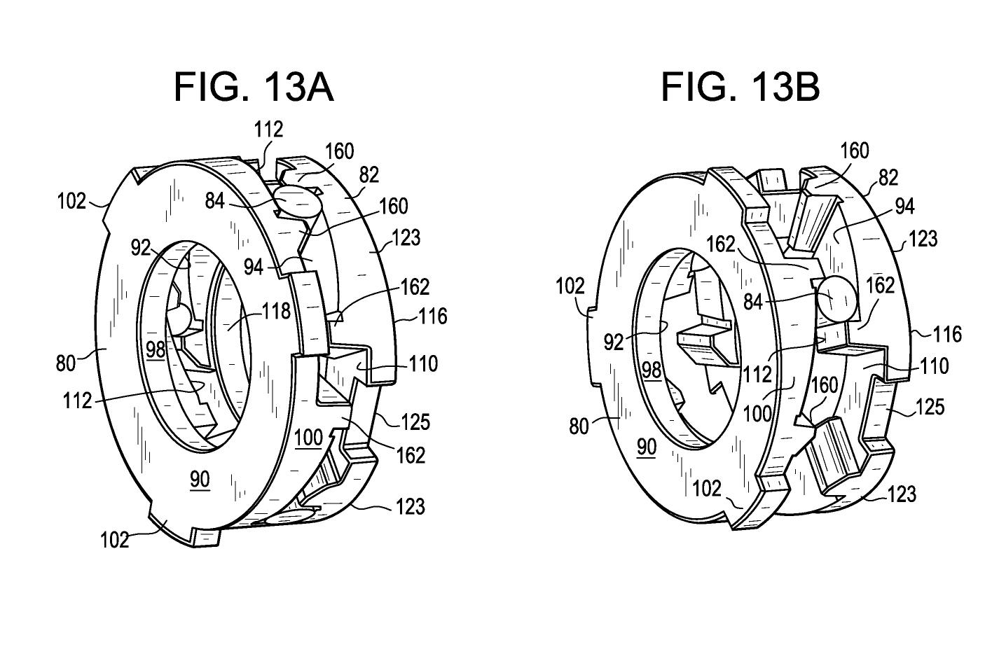

FIG. 12 is an alternate embodiment of the pulley assembly 16. Here, like components have the same reference numbers as those used in FIG. 2. One addition to the embodiment in FIG. 12 is the inclusion of stops on the lower and upper ramp components 80, 82. As seen in FIGS. 12-13B, bottom stops 160 and top stops 162, which limit the travel of the rolling elements 84 and hence the axial displacement of the lower ramp component 82 relative to the upper ramp component 80, are present. The bottom stops 160 and top stops 162 are, as their names suggest, positioned at either the bottom of the inclined features 94 or 112 of the upper ramp component 80 and lower ramp component 82, respectively. The stops 160, 162 provide a torque limiter function to the pulley assembly 16, which is beneficial because it limits the torque applied to the input shaft 78 (shown in FIG. 2) should a high torque transient occur elsewhere in the system 10 (FIG. 1); thus, protecting an accessory connected to the shaft 78 from possible damage. Should the accessory be the source of this high torque transient, the system 10 and belt 30 are protected. For example, damage to bearings, etc. elsewhere in the drive system 10 is minimized or avoided. Torque limiting may also reduce incidence of belt jump. The maximum expansion of the actuator 48, referring back to FIGS. 12-13B, afforded by the stops 160, 162, limits the forces within the pulley assembly 16 to a level determined by the compression of the spring(s) 50. This limited internal force thereby limits the torque capacity of the clutch, beyond which slippage will occur and system protection is provided. Whether the high torque transient originates in the system or accessory, internal damage to the drive pulley 16 is precluded.

Another difference within the embodiment shown in FIG. 12 is that the lower ramp component 82 has cogs 123 as part of the outer surface thereof rather than tabs 122 as seen in FIG. 2. The cogs 123 connect the lower ramp component 82 to the holder 140 when the pulley is assembled by fitting between the tabs 136 of the holder 140. Adjacent cogs 123 are separated from one another by a gap 125 (see FIGS. 13A and 13B) dimensioned to receive the tabs 36 of the holder 140.

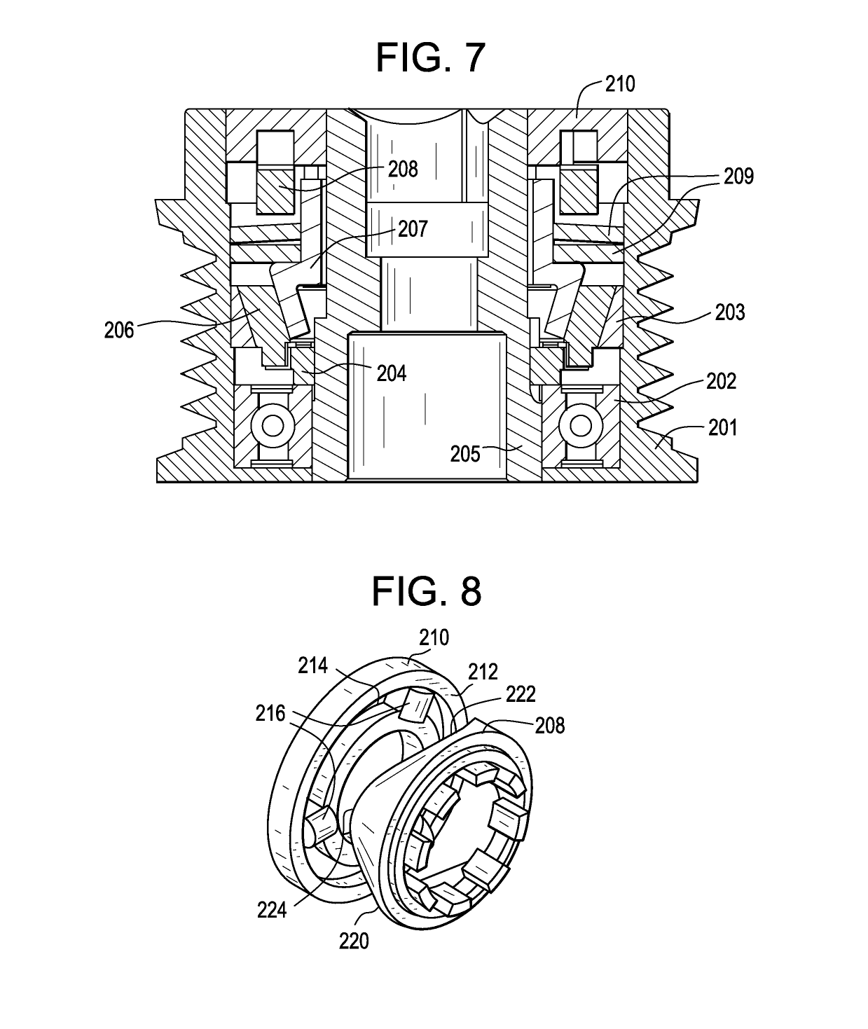

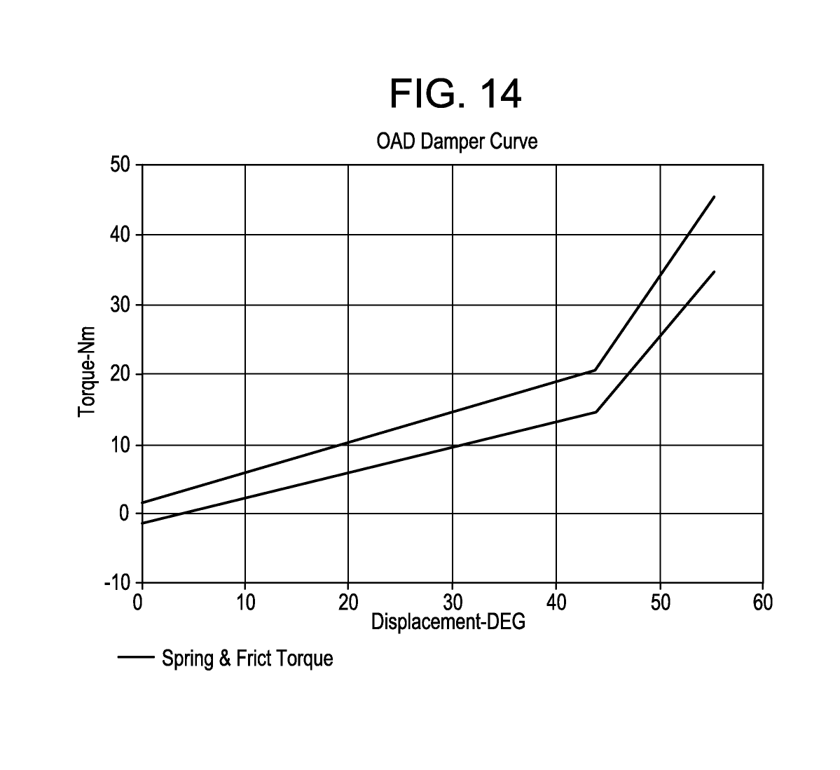

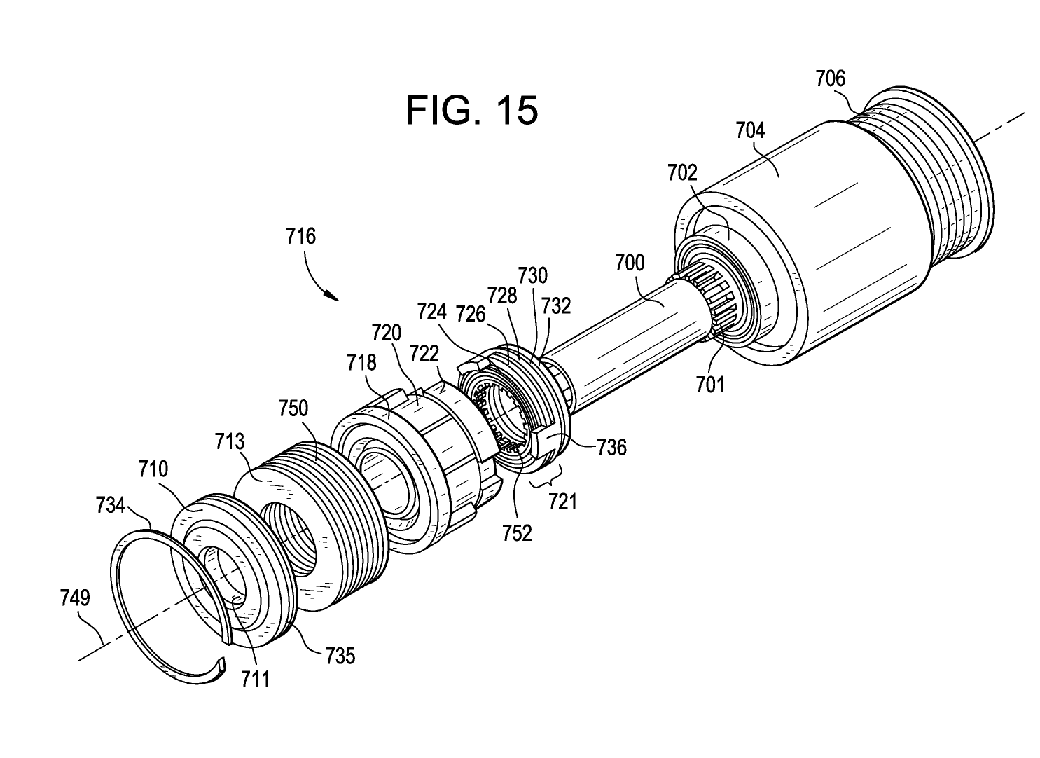

Another difference in the embodiment in FIG. 12, is that a plurality of biasing members 50 (for example a Belleville washer) are present. As illustrated, six biasing members are present, but any number of biasing members can be present such as one, two, three, four, five, six, seven, eight, etc. A plurality of biasing members is also shown in FIGS. 7 and 15. The number of biasing members 50 affects the damping characteristics and spring rate of the pulley assembly 16. As seen in the graph in FIG. 14, a change in the number of springs or a change in the overall assembly stiffness, as a result of altering the spring rate of the springs (use stiffer springs), changes the damper curve (isolation curve). The ascending lines illustrate, during rotation in the predominant direction, that friction is resisting the rotation and that the torque required to rotate the pulley assembly in the predominant direction is increased by the friction amount present during rotation. The change in the slope of each line in FIG. 14 is achieved because there is more than one spring present, in series, within the pulley assembly. Initially all springs of the assembly compress (amount determined by individual stiffness). Assembly stiffness, or spring rate, is less than any individual spring (since they are in series). As load increases on the pulley assembly, an individual spring may lose ability to compress further (in this case a Belleville spring goes ‘flat’—against the end cap 52 (FIG. 12) or drive plate 80. Once a spring goes ‘flat’ it no longer contributes to load change. The remaining spring(s) then determine load change but at a higher rate, hence the steeper slope.

The pulley assembly 16 of FIG. 12 also includes a bearing assembly 324 between the bearing 42 and the holder 140, similar to the bearing assembly seen in FIG. 4, explained in more detail below.

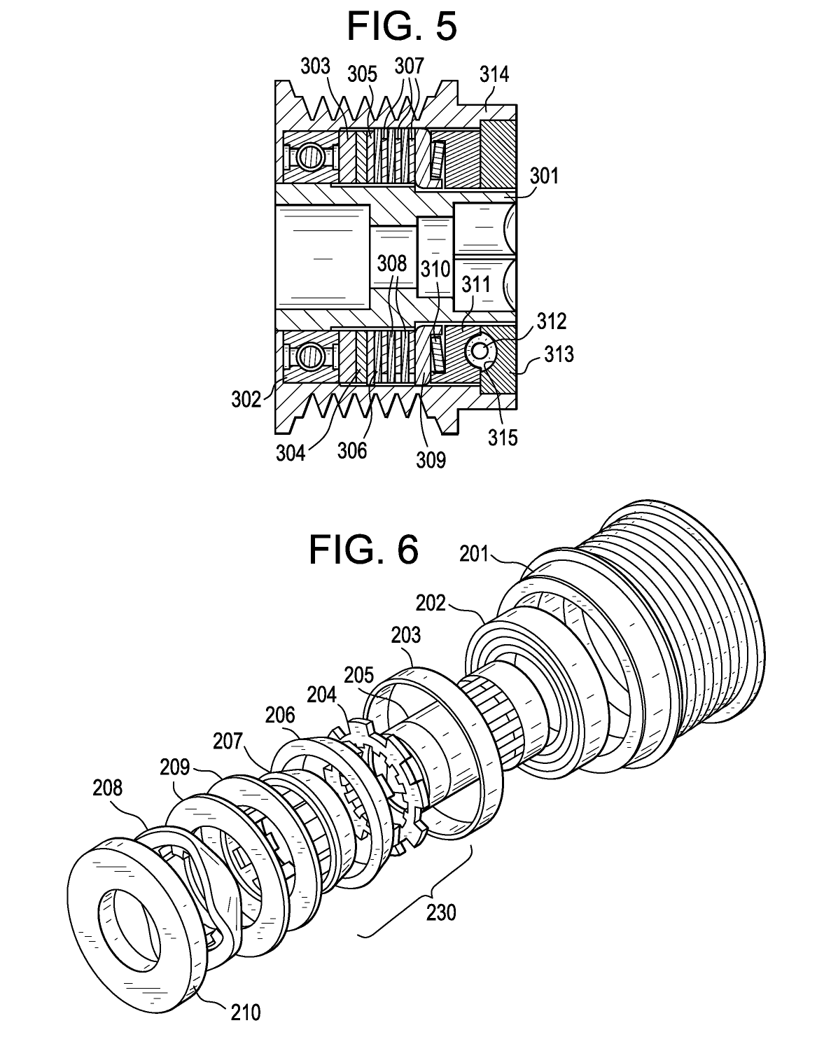

Referring to FIGS. 4 and 5, power input into the pulley assembly is through the pulley body 314 as it is rotated by its contact with a belt. Power output is through the hub 301 (that in use may be affixed to alternator shaft or other accessory shaft). Support between the pulley body 314 and the hub 301 includes bearing 302 and cap 313. Cap 313 is fixed to the pulley body 314 and includes a load support bushing at its inner diameter, to allow relative rotation between the hub 301 and the cap 313 and, by material selection, a controllable portion of Coulomb damping. The lower ramp plate 311, the roller elements 312, and the upper ramp surface 315 (shown in FIG. 5) included in the cap 313 comprise a ball-ramp actuator 320. Relative rotation of the lower ramp plate 311 relative to the cap 313 produces axial displacement, as a result of the contour of the ramps, between lower ramp plate 311 and the cap 313.

The lower ramp plate 311, biasing member 310, and top retainer 309 travel axially to effect clutch actuation. The clutch in this embodiment is shown as a clutch pack 322 comprising a plurality of plates 308, but can also be a cone clutch similar to the cone clutch illustrated in FIGS. 6 and 7. Lower ramp plate 311 is rotatably fixed to the biasing member 310 but is free to translate axially relative to the biasing member 310. The biasing member 310 may be any of the biasing members discussed above, but is not limited thereto. Here, the biasing member 310 is also rotatably fixed to top retainer 309 but is free to translate axially relative thereto. This embodiment has a serial connection that differs from the ramp-ramp embodiment in FIGS. 2 and 3 in that FIGS. 2 and 3 have a sandwich connection where the outer two items (the biasing element 50 and cap 52) are rotatably fixed and other components are free to rotate (sandwich connection). Either embodiment may be used. Axial displacement of the lower ramp plate 311 contacts and moves the biasing member 310 into contact with top retainer 309, which in turn axially contacts the clutch pack 22 comprising friction discs 307, friction core plates 308 and bottom retainer 306. A bearing assembly 324 that includes upper plate 303, roller element plate 304 and lower plate 305 reacts clutch pack load to the pulley, through bearing 302. This embodiment, in addition to having a ball-ramp actuator 320, provides an embodiment that advantageously has minimal damping characteristic. Minimal damping is provided through: (1) use of bearing assembly 324; (2) serial connection of the biasing member 310 to other components; and (3) having the biasing member and the clutch mechanism on the same side of the actuator.

In the embodiment of FIG. 4, the lower ramp plate 311 has an upper surface 344 that faces a lower surface 346 of the cap 313. Both the upper surface 344 and the lower surface 346 have ramp divots 342 that are aligned with each other to allow the rolling elements 312 to reside in the pockets formed by the ramp divots 342 when the lower ramp plate 311 and the cap 313 are assembled. The ramp divots 342 have a socket 352 for receiving the rolling element 312 and a divot tail 354 as shown in FIG. 4. The socket 352 has a depth of at least equal to the dimensions of the rolling elements 312. The divot tail 354 has a first end that starts at a depth equal to the socket 352 and gradually becomes shallower until a second end of the divot tail 354 is flush with the upper surface 344 of the lower ramp plate 312, or the lower surface 346 of the cap 313 depending on the location of the ramp divot 342.

The ramp construction or roller-ramp construction illustrated in FIG. 4 may also be described as inclined features as set forth above for FIGS. 2 and 3.

Referring to FIGS. 6-8, power input into the pulley assembly is through the pulley body 201 as it is rotated by its contact with a belt. Power output is through hub 205 (that in use may be affixed to alternator shaft or other accessory shaft). Support between the pulley body 201 and the hub 205 consists of bearing 202 and cap 210. Cap 210 includes a load support bushing at its inner diameter, to allow relative rotation between the pulley body 201 and the hub 205 and, by material selection, a controllable portion of Coulomb damping. Cap 210 and cam 208 comprise a ramp-ramp or cam-follower actuator. As seen in FIG. 8, cap 210 includes, in its inner surface 212, a track or groove 214 that includes hurdles 216 spaced apart within the track 214. The hurdles 216 may have arcuate ends or ends having sloped or inclined surfaces facing the cam 208 such that relative rotation between the cam 208 and the cap 210 produces axial displacement of the cam 208, as a result of the contour of the ramp surfaces of the cam moving rotationally along the hurdles 216. Cam 208 includes an upper surface 220 that is contoured to provide a camming action that results in the axial displacement of the cam 208 during rotation thereof. The contour may include alternating, or even undulating, valleys 222 and peaks 224. The valleys 222 of the contour are located opposite the hurdles 216 when the pulley assembly is in a rest position. Positive input from the pulley body 201 results in relative rotation in a positive sense, negative input results in relative rotation in the negative sense from the rest position. Positive and negative ramp slopes, or profiles, are shown as identical in FIGS. 6-8, but the assembly is not limited thereto. In practice these ramp slopes, or profiles on the hurdles 216 and the contour of the upper surface 220 of the cam 208 may be different slopes or profiles.

Inner cone ring 207, cam 208 and biasing elements 209 provide axial travel and force to apply a clutch 230 having cone-shaped members. Cam 208 is rotatably fixed to inner cone ring 207 but is free to translate axially relative thereto. Axial displacement of cam 208 contacts and moves the biasing elements 209 into contact with the inner cone ring 207, which in turn translates the inner cone ring 207 axially into contact with intermediate cone ring 206. Intermediate cone ring 206 translates axially, as a result, into contact with outer cone ring 203. Outer cone ring 203 is axially and rotatably fixed to the pulley body 201. Additional displacement of cam 208 will compress biasing members 209. This compressive force is transmitted to inner cone ring 207 and intermediate cone ring 206, and then intermediate cone ring 206 frictionally engages the outer cone ring 203. The inner, intermediate, and outer cone rings 207, 206, 203 and hub connector 204 comprise the clutch 230. The inner cone ring 207 and the outer cone ring 203 are connected to the input (i.e., the pulley body 201), and the intermediate cone ring 207 and the hub connector 204 are connected to the output (i.e., the hub 205). Intermediate cone ring 206 is rotatably fixed to the hub connector 204, but is free to translate axially relative thereto through drive lugs. Hub connector 204 is rotatably fixed to the output, hub 205.

The cone clutch in FIGS. 6-8 is illustrated and described as a two-element clutch, two components are movable. In practice, by application requirements, this clutch may also be a single-element or multiple-element clutch. Also the cone element angle is illustrated as identical on the outer, intermediate, and inner cone rings 203, 206, 207, but is not limited thereto. In practice, again by application requirements, the cone angles may be significantly non equal.

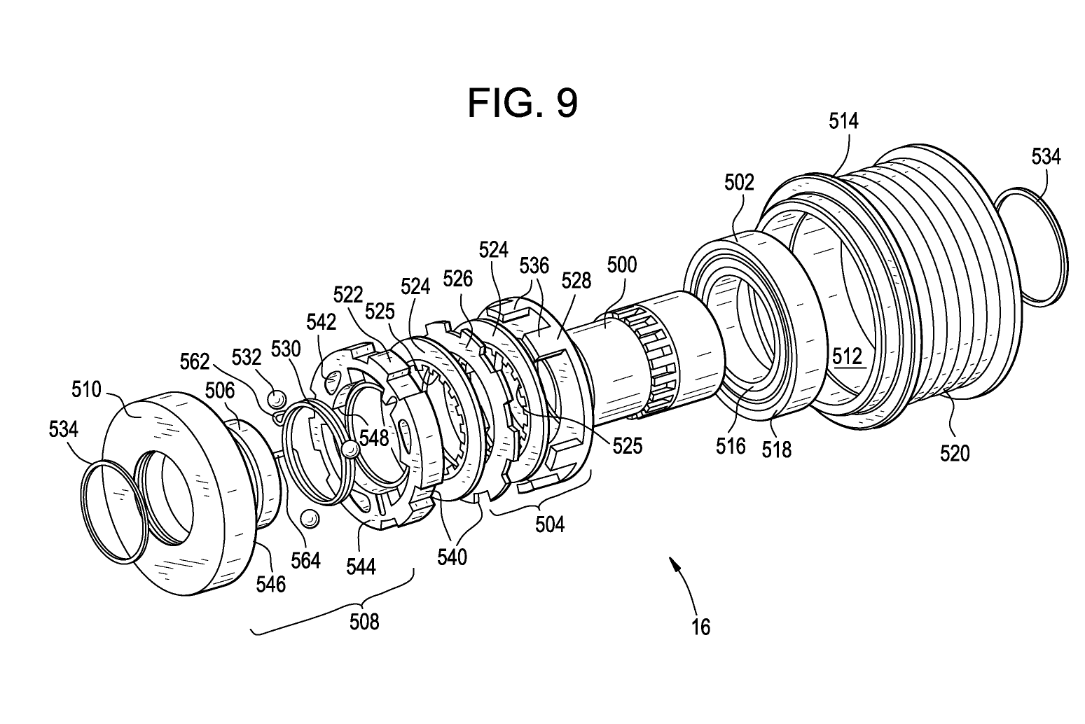

Referring now to FIGS. 9-11, in one embodiment the pulley assembly 16 may include a hub 500 that is engageable with the input shaft of the accessory (not shown, but see FIG. 2 shaft 78), a roller bearing 502, a one-way clutch mechanism 504, a bushing 506, a clutch actuator 508, and sealing O-rings 534 that are all housed within the bore 512 of a pulley body 514. The one-way clutch mechanism 504 includes friction discs 524, a clutch plate 526, and a holder 528 for the friction discs 524 and clutch plate 526 (so that they all rotate as a unit when the one-way clutch is engaged). The clutch actuator 508 includes a drive plate 510, a ramp plate 522, rolling elements 532, and a preload spring 530. The hub 500 may be mated to the input shaft (not shown) by a Woodruff key, as is well known, to prevent the hub 500 from freely rotating about the input shaft. Of course other connections between the hub 500 and the input shaft are also possible including, for example, a spline.

The roller bearing 502 may be located between the hub 500 and the pulley body 514 to permit stable rotation of the pulley body 514 relative to the hub 500 when disengaged. The inner race 516 of the roller bearing 502 may be adjacent and coupled to the hub 500. The outer race 518 of the roller bearing 502 may be adjacent and coupled to the pulley body 514. The use of a roller bearing may improve the overall structural rigidity of the assembly and extend the life of the assembly by reducing wear as elements of the clutching mechanism rotate relative to one another.

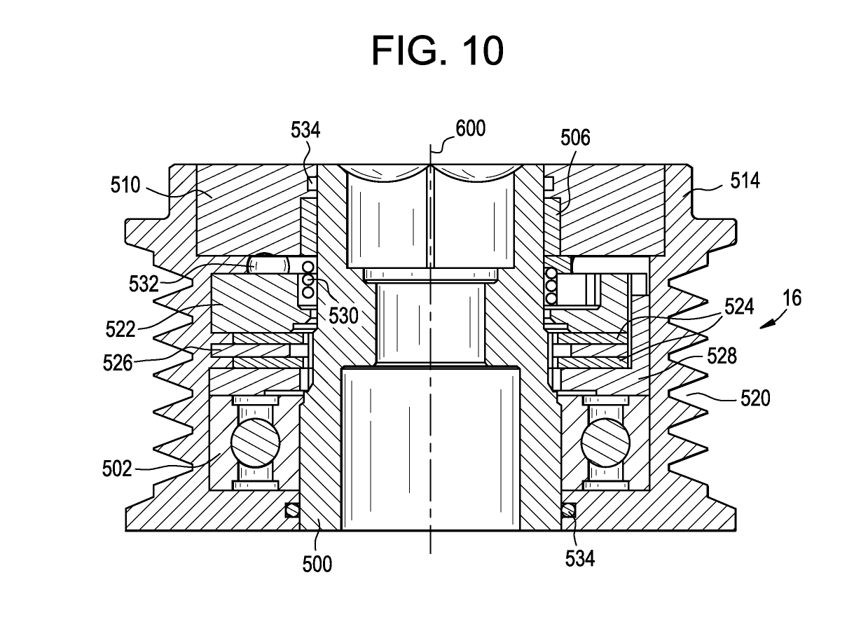

As illustrated in FIGS. 9 and 10, the pulley body 514 is located about the hub 500 and includes a central bore or opening 512 that is sized such that the pulley body can rotate about the hub. The pulley body 514 also includes an outer, peripheral belt-engaging surface 520 that can engage a belt such as belt 30 in FIG. 1. In the illustrated embodiment, the belt-engaging surface 520 is profiled with V-shaped ribs and grooves to mate with corresponding ribs and grooves of a belt. Other configurations are possible, such as cogs, flat or rounded ribs and grooves.

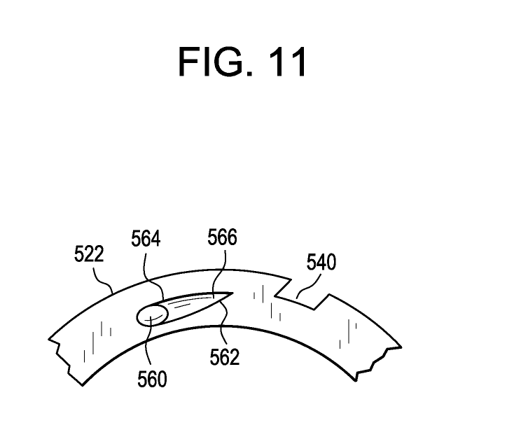

Turning now to the components of the actuator 508, FIG. 9, the ramp plate 522 has an upper surface 544 that faces a lower surface 546 of the drive plate 510. Both the upper surface 544 and the lower surface 546 have ramp divots 542 that are aligned with each other to allow the rolling elements 532 to reside in the pockets formed by the ramp divots 542 when ramp plate 522 and drive plate 510 are assembled. The ramp divots 542 have a socket 560 for receiving the rolling element 532 and a divot tail 562 as shown in FIG. 11. The socket 560 has a depth of at least equal to the dimensions of the rolling elements 532. The divot tail 562 has a first end 564 that starts at a depth equal to the socket 560 and gradually becomes shallower until a second end 566 of the divot tail 562 is flush with the upper surface 544 of the ramp plate 522, or the lower surface 546 of the drive plate 510 depending on the location of the ramp divot 542 and thereby defines an inclined plane along which the rolling elements 352 can roll.

The ramp construction or roller-ramp construction illustrated in FIG. 9 may also be described as inclined features as set forth above for FIGS. 2 and 3 or FIGS. 12-13B.

As seen in FIG. 9, the upper surface 544 of the lower ramp plate 522 includes a first recess 548 defining a seat for a first end 562 of the preload spring 530. Similarly, the lower surface 546 of the drive plate (or cap) 510 includes a second recess (not shown) defining a seat for a second end 564 of the preload spring 530. When assembled, the first end 562 of the preload spring 530 is inserted into the first recess 548 in lower ramp plate 522 and the second end 564 of the preload spring 530 is inserted into the second recess in the drive plate 510. The rolling elements 532 are placed within the aligned ramp divots 542 and held between the drive plate 510 and the lower ramp plate 522. The bias of the preload spring 530 rotates the lower ramp plate 522 slightly in the predominate rotational direction relative to the drive plate 510. As a result, the rolling elements 532 travel slightly up the divot tail 562. As the rolling elements 532 travel up the divot tail 562, they push against the drive plate 510 and the lower ramp plate 522, which results in an axial separation of drive plate 510 and lower ramp plate 522. Lower ramp plate 522 moves axially towards holder 528. This axial translation moves ramp plate 522 to the right in FIG. 9 and toward the bottom of the page in FIG. 10, which in turn urges the friction discs 524 and clutch plate 526 of the one-way clutch mechanism 504 to translate axially toward the holder 528 resulting in increased frictional engagement between the friction discs 524 and the clutch plate 526. Once the friction discs 524 are moved into frictional engagement, all the components of the one-way clutch mechanism 504 rotate together as a unit so that the hub 500, which is coupled to the friction discs 524 for rotation therewith, will rotate with the pulley body 514. This is the engaged position of the clutch.

As illustrated in FIG. 10, the bushing 506 is rotatably fixed to the drive plate 510. The inner race 516 of the roller bearing 502 is rotatably fixed to hub 500, and the outer race 518 of the roller bearing 502 is rotatably fixed to pulley body 514. The bushing 506 and the roller bearing 502 provide radial support of the pulley body 514 to the hub 500. The bushing 506 allows relative rotation between the hub 500 and the drive plate 510 and, by material selection, a controllable portion of Coulomb damping for the pulley assembly 16.

The axial expansion of the clutch actuator 508 during rotation of the pulley body 514 in the predominate rotational direction actuates the one-way clutch mechanism 504 which couples the pulley body 514 to the hub 500 to transmit power from a belt such as belt 30 in FIG. 1 to the input shaft (not shown) of an accessory. The one-way clutch mechanism 508 includes a plurality of alternating friction discs 524 and clutch plates 526. Each friction disc 524 and clutch plate 526 has a bore therethrough to receive the shaft of the hub 500. The friction discs 524 have an inner diameter that defines a bore surface that includes a key or keyway 525 for mating engagement with the hub 500 for rotation therewith. In one embodiment, the friction discs 524 and the hub 500 have a splined connection. The clutch plate(s) 526 and lower ramp plate 522 include a key, keyway, tabs, splines, cogs 540, or the like on the surface defining its outer diameter. The cogs 540 are received between tabs 536 on the holder 528.

The pulley assembly 16 in FIG. 10, in particular the hub 500 thereof, defines an axis of rotation 600. When the one-way clutch mechanism 504 is engaged, the pulley body 514 rotates the input shaft of the accessory. The engaged position is achieved by axial displacement provided through the relative rotation of the pulley body 514 and the axial movement of the component(s) of the one-way clutch mechanism 504 to engage the pulley body 514 with the hub 500 for rotational movement together about the axis of rotation 600.

During an overrunning condition, the hub 500, and hence the input shaft, disengages from the pulley body 514 and continues to rotate with momentum in the first rotational direction (the predominant direction) when the pulley body 514 experiences a relative torque reversal or sudden slowdown. In this condition, the pulley body 514 may continue to rotate in the first rotational direction but with less angular velocity than the velocity at which it had been driving the input shaft. The sudden decrease of angular velocity at the pulley body 514 has the effect of a relative reversal of torque, which overcomes the bias of the preload spring 530. This results in the aligning of the ramp divots 542 and the rolling elements 532 traveling into the sockets 542. When the rolling elements 532 are in the sockets 542 the axial expansion between the lower ramp plate 522 and the drive plate 510 is reduced, which relieves the one-way clutch mechanism 504 of the forces that moved it into the engaged position. As the contact pressure and friction force between the components of the one-way clutch mechanism 504 decrease, they will eventually disengage the one-way clutch mechanism 504, which uncouples the pulley body 514 from the hub 500 so that they can rotate relative to one another with minimal friction such that the input shaft rotates independently of the pulley body 514.

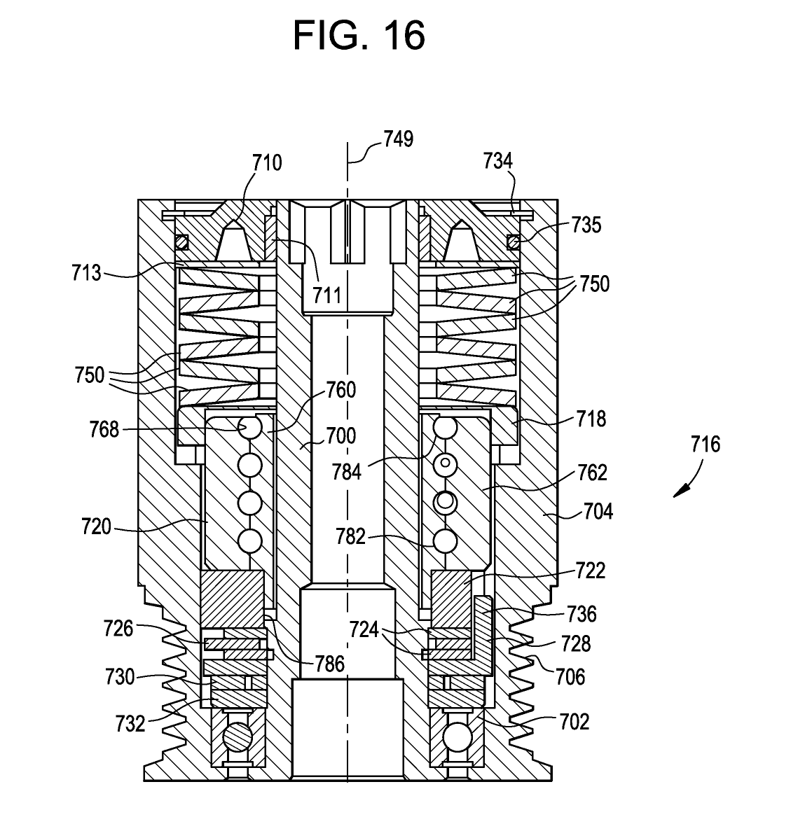

Referring to FIGS. 15 and 16, power input into the pulley assembly 716 is through the pulley body 704 as it is rotated by its contact with a belt such as belt 30 in FIG. 1. Power output is through the hub 700 (that in use may be affixed to a shaft to operate another device). Support between the pulley body 704 and the hub 700 includes bearing 702 and cap 710. Cap 710 is fixed to the pulley body 704 and includes a load support bushing 711 to allow relative rotation between the hub 700 and the cap 710 and, by material selection, a controllable portion of Coulomb damping. In this embodiment, the actuator capable of axial expansion when the pulley body rotates in a predominant direction is a ball screw actuator 720, which is disposed about the hub 700. The clutch mechanism in FIGS. 15-16 is a clutch pack 721 disposed about the hub and activatable into an engaged position by the axial expansion of the actuator 720. In another embodiment, the clutch mechanism may be a cone clutch such as that described above with respect to FIG. 6.

Moving from left to right in FIG. 15 the pulley assembly includes a retaining ring 734, seal 735, a cap 710, a bushing 711, preload spring 713, springs 750, spring seat 718, ball screw actuator 720, drive plate 722, clutch pack 721, bushing 730, plate 732, shaft 700, bearing 702, and pulley body 704. The pulley body 704 includes a belt-engaging surface 706. The cap 710 may also include a secondary seal 735 such as an 0-ring. The springs 713, 750 act to bias components of the pulley assembly 716 axially for maintained engagement during operation of the pulley. In FIGS. 15-16 the springs 50 are a plurality of Belleville washers. The number of springs may be varied as well as the material of the springs to change the characteristics of the pulley assembly as described above. The ball screw actuator 720 and clutch pack 721 will be described below. The bearing 702 is as described above in the other embodiments and provides the same advantages.

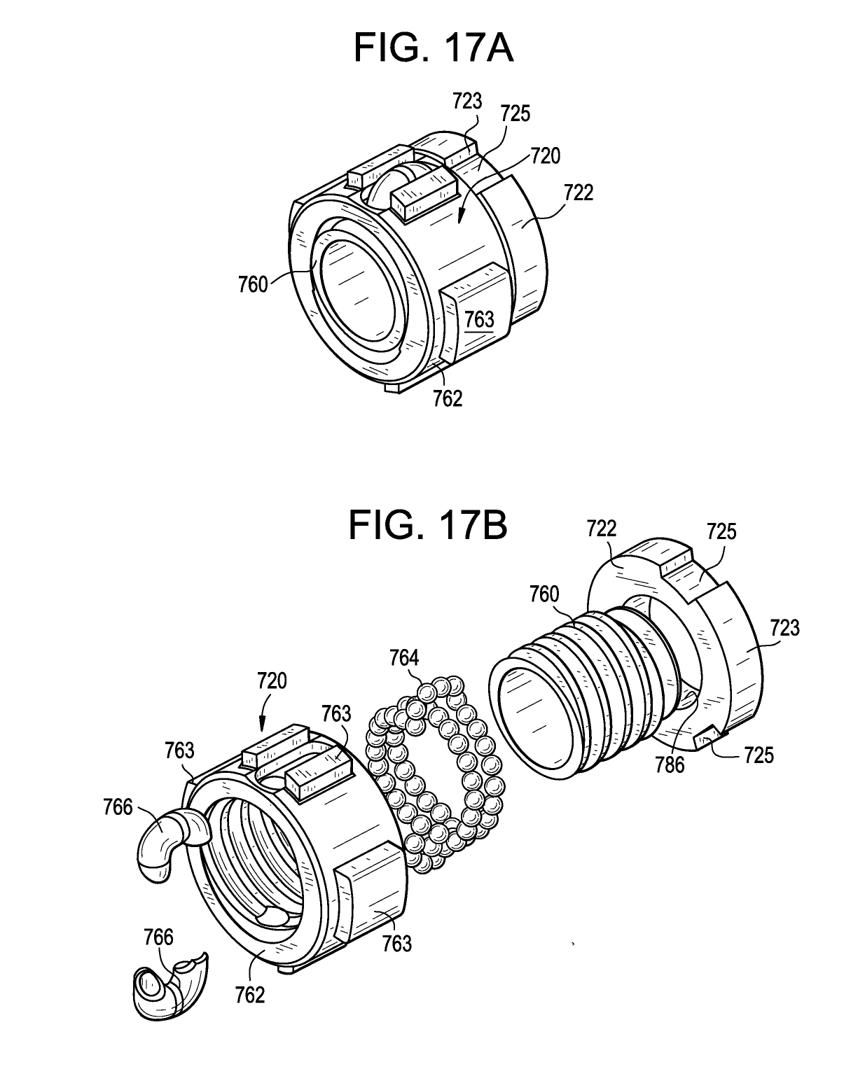

As seen in FIG. 16 and the exploded view FIG. 17B, the ball screw actuator 720 includes a threaded shaft 760 having a nut 762 disposed about the shaft such that the shaft 760 and the nut 762 define a raceway 768 (FIG. 16) for a plurality of rolling elements 764 (FIG. 17B). The ball-screw actuator 720 also includes a ball tube 766 (FIG. 17B) connecting the bottom of the raceway 782 (FIG. 16) to the top of the raceway 784 (FIG. 16) to recirculate the rolling elements 764. The threaded shaft 760 is connected to the drive plate 722. As seen in FIGS. 16 and 17B, the threaded shaft 760 may be seated in a bore 786 of the drive plate 722. The drive plate 722 includes a key, keyway, tabs, splines, cogs, or the like 725 in or extending from the surface defining its outer diameter. In the embodiment of FIGS. 15-17B, the drive plate 722 has cogs 723 as part of the outer surface thereof separated from adjacent cogs 723 by gap 725 which is dimensioned to receive the tabs 736 of the holder 728. As assembled in FIG. 16, the tabs 736 of the holder are seated in the gaps 725 of the drive plate 722, but the drive plate 722 is able to translate axially relative to the holder 728.

As seen in FIGS. 17A and 17B, the nut 762 also includes keys or splines 763 that mate with keyways (not shown) inside the bore of the pulley body 704. This splined connection (or key-to-keyway connection) mates the nut 762 to the pulley body 704 for rotation together about the axis of rotation 749 defined by the shaft 700.

The clutch mechanism in FIGS. 15-17B is shown as a clutch pack 721 comprising a plurality of plates of alternating friction discs 724 and clutch plates 726. In one embodiment, the clutch pack 721 may include just one clutch plate 726 and two friction discs 724 packed into a holder 728. The holder 728 is as described above. The friction discs 724 are splined (see splines 752) such that they are connected to the mating splines 701 of the shaft 700 such that the shaft 700 is rotatably connected to the friction discs 724, but the friction discs 724 are still free to axially translate relative to the shaft 700. Accordingly, when the clutch pack 721 is activated by axial expansion of the ball screw actuator 720, the friction discs 724 and clutch plates 726 are moved axially into frictional engagement with one another such that they will rotate together as a unit.

As just described, the ball screw actuator 720, during operation of the pulley assembly, axially expands to activate the clutch mechanism 721. The nut 762 is keyed to the pulley body 704 for rotation therewith, and when the pulley 704 rotates in the predominant direction, the nut 762 rotates therewith about the threaded shaft 760 until the nut 762 has moved axially to an expanded position that moves the drive plate 722 away from the nut 762 and into engagement with the components of the clutch pack 721. As a result of the axial movement of the drive plate 722, the clutch pack components are also moved axially into frictional engagement with one another. Now, the clutch pack 721 is engaged and the pulley body 704 and the shaft 700 are connected for rotation together about the axis of rotation 749.

Then, when the pulley body 704 rotates in a direction opposite the predominant direction, for example, experiences a torque reversal, the clutch pack 721 disengages from the actuator 720 as a result of the actuator 720 rotating with the pulley body 704 and thereby relieving the axial expansion (contracting back to a non-engaged position) which allows the hub 700 to rotate independently of the pulley body 704. The hub 700 can continue to rotate in the predominant direction under its remaining momentum, which can allow the hub to rotate at speeds greater than speeds of the pulley body. This is also known as an overrun or freewheel position.

In FIGS. 15 and 16, the biasing members 750 are positioned between the actuator 720 and the cap 710. However, the biasing members 750 are not limited to this position. In another embodiment, similar to FIG. 4, the biasing members may be disposed between the actuator and the clutch mechanism, clutch pack 721.

Various parameters can affect the operation, responsiveness, and performance of the pulley assemblies disclosed herein, including the angle, slope, or profile ramp or camming surfaces, the coefficients of friction between components in frictional engagement with one another, and the spring rate of the biasing member. Other factors that affect the selection of a particular combination include wear, primary clutching, durability and cost.

Overrun torque protection may be provided in all embodiments herein. However, specific to FIG. 9, overrun torque (drag torque) is the summation of the preload torque, seal and bearing and/or bushing drag. Accordingly, the overrun torque is adjustable by changing the preload spring 530, 713, etc. and through selection of seals and bushings (i.e., the materials they are made of to alter the coefficient of friction within the pulley assembly).

Various embodiments are disclosed herein, and one of skill in the art should appreciate that the various actuators, clutch mechanisms and spring configurations can be mixed and matched to create additional embodiments. Additionally, in one embodiment, the pulley assembly may be connected to a crank shaft and used to drive a belt. To operate in such an application, the order of the components in the pulley assembly are reversed such that the actuator is connected to the hub (and hence the crank shaft) and the clutch mechanism in an engaged position links the hub to the pulley body for simultaneous rotation. Any of the embodiments disclosed herein or mixed and matched as indicated above as an option can be “reversed” as just described, so that the pulley assembly can be mounted to a crank shaft. Here, the pulley body has a bore and the hub, which defines an axis of rotation, is disposed within the bore. An actuator, such as a ramp-ramp unit, roller-ramp unit, ball-ramp unit, cam-follower unit or the like that axially expand when the hub is rotated in the predominant direction, is disposed about the hub. Additionally, a clutch mechanism is disposed about the hub. The clutch mechanism is activated into an engaged position by the axial expansion of the actuator. In this engaged position the activation of the clutch mechanism links the hub to the pulley body for simultaneous rotation in the predominant direction. Then when the crank shaft experiences a deceleration (the hub also experiences the deceleration), the pulley assembly enters an overrun position where the clutch mechanism disengages, typically as a result of the contraction of the actuator, and allows the pulley body to rotate at speeds greater than the hub.

The embodiments have been described in detail with respect to the figures presented herein, but it is apparent that numerous variations and modifications are possible without departing from the spirit and the scope of the invention as defined in the following claims.

What is claimed is:

1. A pulley assembly comprising:
a pulley body having a bore;
a hub defining an axis of rotation disposed within the bore of the pulley body;
an actuator disposed about the hub, the actuator capable of axial expansion when the pulley body rotates in a predominant direction; and
a clutch mechanism disposed about the hub, the clutch mechanism being activatable into an engaged position by the axial expansion of the actuator;
wherein in the engaged position the axial expansion of the actuator activates the clutch mechanism, which links the pulley body to the hub for simultaneous rotation in the predominant direction.

2. The pulley assembly of claim 1 wherein the actuator includes a ramp-ramp unit, a roller-ramp unit, a cam-follower unit, or a ball-screw unit that expands axially when the pulley body rotates in the predominant direction.

3. The pulley assembly of claim 2 wherein the actuator includes the roller-ramp unit, the roller-ramp unit having one or more roller elements disposed between an upper ramp component and a lower ramp component.

4. The pulley assembly of claim 2 wherein the one or more roller elements are spherical, uniformly cylindrical, or tapered cylindrical bearings.

5. The pulley assembly of claim 2 further comprising a biasing member biasing the components of the actuator axially into maintained contact during operation of the pulley assembly.

6. The pulley assembly of claim 5 wherein the biasing member is disposed between the actuator and a cap or between the actuator and the clutch mechanism.

7. The pulley assembly of claim 5 wherein the biasing member includes one or more Belleville washers.

8. The pulley assembly of claim 5 wherein the biasing member is a coil spring disposed between an upper ramp component and a lower ramp component.

9. The pulley assembly of claim 1 wherein the clutch mechanism includes a clutch pack or a cone clutch.

10. The pulley assembly of claim 9 wherein the clutch mechanism is the clutch pack and the clutch pack includes at least one clutch plate and at least one friction disc.

11. The pulley assembly of claim 10 wherein either the clutch plate or the friction discs are coupled to the hub for rotation therewith while being translatable therealong and the other is coupled to the actuator for rotation therewith while being translatable along the hub.

12. The pulley assembly of claim 1 wherein when the pulley body rotates in a direction opposite the predominant direction or experiences a deceleration, the clutch mechanism disengages from the actuator and allows the hub to rotate independently of the pulley body in the predominant direction under its own momentum.

13. The pulley assembly of claim 2 wherein the clutch mechanism includes a clutch pack or a cone clutch.

14. The pulley assembly of claim 1 wherein when the pulley body rotates in a direction opposite the predominant direction or experiences a deceleration, the pulley assembly enters an overrun position where the clutch mechanism disengages from the actuator and allows the hub to rotate at speeds greater than the pulley body.

15. The pulley assembly of claim 2 wherein the actuator is a ball screw comprising a nut coupled to the pulley body for rotation therewith and being translatable relative thereto, a threaded shaft about which the nut is disposed, and a plurality of rolling elements recirculating within a raceway defined between the nut and the threaded shaft.

16. The pulley assembly of claim 1 wherein the actuator provides isolation from and damping of torsional excitations.

17. A pulley assembly comprising:
a pulley body having a bore;
a hub defining an axis of rotation disposed within the bore of the pulley body;
an actuator disposed about the hub, the actuator capable of axial expansion when the hub rotates in a predominant direction; and
a clutch mechanism disposed about the hub, the clutch mechanism being activatable into an engaged position by the axial expansion of the actuator;
wherein in the engaged position the axial expansion of the actuator activates the clutch mechanism, which links the hub to the pulley body for simultaneous rotation in the predominant direction.

18. The pulley assembly of claim 17 wherein when the hub experiences a deceleration, the pulley assembly enters an overrun position where the clutch mechanism disengages from the actuator and allows the pulley body to rotate at speeds greater than the hub.
